(19) United States
(12) Patent Application Publication
(10) Pub. No.: US 2017/0157616 A1
(43) Pub. Date: Jun. 8, 2017

(54) TRANSMISSION HOLDER FOR A ROLLER PRESS AND METHOD FOR DISMANTLING THE TRANSMISSION OF A ROLLER PRESS

(71) Applicant: TAKRAF GmbH, Leipzig (DE)

(72) Inventor: Meinhard FRANGENBERG, Kürten-Engeldorf (DE)

(73) Assignee: TAKRAF GmbH, Leipzig (DE)

(21) Appl. No.: 15/365,594

(22) Filed: Nov. 30, 2016

(30) Foreign Application Priority Data
Nov. 30, 2015 (DE) 10 2015 223 694.3

(51) Int. Cl. B02C 4/42; F16H 57/025

(52) U.S. Cl. CPC B02C 4/426; F16H 57/025; F16H 2057/02069

(57) ABSTRACT

The transmission holder according to the invention for a roller press has a two-part structure with a transmission part which is connected to the transmission and a separate torque supporting part which is to be connected to the machine base frame or foundation. Transmission and torque supporting part of the transmission holder can be detachably connected to one another, preferably by means of a screw or bolt connection. In one embodiment this connection has two screws or bolts. Advantageously the dismantling or assembly of the rollers can thus be accomplished significantly more simply than according to the prior art since merely the screw or bolt connection between transmission and transmission holder of the transmission holder must be released. Advantageously significantly fewer screws/bolts need to be released for dismantling the transmission which in addition are more readily accessible and have a significantly greater distance from one another than according to the prior art. In addition, no unilateral gravitation forces act after dismantling as a result of the symmetrical transmission part. Likewise the tightening torque of the screws/bolts advantageously does not play a very important role. As a further advantage the transmission holder according to the invention can be manufactured simply and cost-effectively. As a result of the compact shape of the transmission part, advantageously low moulding and manufacturing costs are also incurred.

The invention relates to a transmission holder for a roller press, a roller press comprising such a transmission holder and a method for dismantling a transmission of a roller press.

In many roller presses a transmission is arranged between the drive motors and the rollers. This transmission is fastened via a transmission holder which also functions as a torque support, on the foundation or if provided, foundation framework of the roller press. Torque support means here that any rotation of transmission or drive motor relative to the machine frame of the roller press is prevented.

These transmission holders according to the prior art are configured as large flat non-symmetrical steel parts, projecting far to one side, with regard to the forces to be transmitted from the drive torque, which are fastened to the transmission via a flange with a plurality of large screws. This connection requires a uniform tightening of the screws which in practice is very difficult since a suitable tool which is suitable both for the size of the screws and also for the short screw spacings barely exists and therefore the screws are usually “hammered on” with a hammer. This seems particularly relevant bearing in mind that the rollers of a roller press must be regularly dismounted for maintenance work and for this purpose the transmission with transmission holder mounted thereon must be pulled away from the shaft. The transmission holder projecting far to one side is very obstructive here since on the one hand the space for dismantling must be taken into account and on the other hand, the gravitational force attempts to turn the transmission with the transmission holder. The alternative to dismount the transmission holder from the transmission is possible but very complex with regard to the large number of screws and therefore time-consuming. For example, for transmission maintenance this expenditure is unavoidable.

Such a transmission holder according to the prior art is disclosed for example in the prospectus “Single-grinding. Grinding systems from KHD Humboldt Wedag.” 2-201d (von 7/2000) on page 15. Last but not least the fastening by the large number of screw is time-consuming and the transmission holder requires a high production effort and therefore high manufacturing costs.

It is the object of the present invention to provide a transmission holder which overcomes the said disadvantages of the prior art.

This object is solved according to the invention by a transmission holder having the features of claim 1. Preferred further developments of the invention are the subject matter of subclaims. A roller press according to the invention is the subject matter of claim 7 and the method for dismantling the transmission of a roller press is the subject matter of claim 12.

The transmission holder according to the invention for a roller press has a two-part structure with a transmission part which is connected to the transmission and a separate torque supporting part which is to be connected to the machine base frame or foundation. Transmission and torque supporting part of the transmission holder can be detachably connected to one another, preferably by means of a screw or bolt connection. In one embodiment this connection has two screws or bolts. Advantageously the dismantling or assembly of the rollers can thus be accomplished significantly more simply than according to the prior art since merely the screw or bolt connection between transmission and transmission holder of the transmission holder must be released. In addition, the possibility thus advantageously exists of folding away the torque supporting part to the side after releasing the connection between torque supporting part and transmission part and thereby significantly increasing the installation space for dismantling the transmission.

The connection of the transmission holder according to the invention to the machine base frame or the foundation is made according to the prior art. Frequently a torsion shaft is incorporated via connection elements between the connection points of transmission holder and machine base frame/foundation. The positioning of the torsion shaft can naturally also be accomplished in different ways, for example without connecting elements directly at the connection points between transmission holder and machine base element or foundation or also integrated in the machine frame. Within the framework of the application the formulation connection of machine base frame or foundation comprises a direct connection or an indirect connection via connecting elements or similar.

Advantageously, significantly fewer screws/bolts thus need to be released which additionally are more easily accessible and have a significantly greater distance from one another than according to the prior art. In addition, no unilateral gravitation forces act after dismantling as a result of the symmetrical transmission part. Likewise the tightening torque of the screws/bolts advantageously does not play a very important role. As a further advantage the transmission holder according to the invention can be manufactured simply and cost-effectively. As a result of the compact shape of the transmission part, advantageously low moulding and manufacturing costs are also incurred.

In one embodiment both parts of the transmission holder are symmetrical with respect to their central mid plane. As a result the same torque supporting part can be used for both transmissions of a roller press by simply installing reversed. This advantageously enables a cost-effective holding of replacement parts.

The compact and symmetrical shape of the transmission part of the torque supporting part according to the invention for the case when this transmission holder is cast fixedly on the transmission housing eliminates any right or left design of the transmission.

In one embodiment, the connection of transmission part to the transmission is made as a seamless connection. For example the transmission part is produced during primary moulding of the transmission housing. Alternatively the connection can also be made by welding. Advantageously the connection is thus made simply and cost-effectively and very stably.

In another embodiment the connection of the transmission part to the transmission is made by means of a screw or bolt connection according to the prior art. Advantageously the transmission holder according to the invention can thus also be retrofitted to existing roller presses. The complex screw connection between the transmission part of the transmission holder and the transmission must only be made once, for subsequent dismantlings the connection between the transmission part and the torque supporting part is then always released.

In a further embodiment the transmission part of the transmission holder has a rectangular base shape with an opening for passage of the output shaft of the transmission. Preferably holes for the bolt connection to the torque supporting part are provided in the region of the corners of the rectangular basic shape.

In one embodiment the torque supporting part is configured as substantially triangular, wherein two corners of the triangle are bolted with the holes in the corner regions of the transmission and the third corner is to be connected to the machine frame or the foundation of the roller press, wherein one of the two connecting bolts to the transmission part is also connected to the machine frame or the foundation. Such a structure of the transmission holder can be made particularly simply and cost-effectively, can be fastened well and can receive forces well.

In another embodiment one of the two parts of the transmission holder is configured in a fork shape in the connecting region to the other part. The fork shape embraces the respectively other part in the connected state. Advantageously the connection of transmission part and torque supporting part can thus be significantly stabilized, in particular considerably higher torques can be received.

The roller press according to the invention comprises a previously described transmission holder according to the invention. Advantageously such a complex screw connection between transmission holder and transmission can be omitted and thus also expensive screw tightening tools for highly-loaded screw connections. In addition, the compact and simple design of the transmission holder incurs low moulding and therefore manufacturing costs.

Further advantageously after releasing the connection to the transmission part, the torque supporting part can be pivoted away laterally which significantly improves the handling of the transmission during the dismantling and assembly from/onto the rollers.

The compact shape of the transmission part additionally allows a very much smaller space requirement during dismantling and assembly of the transmission from/onto the rollers and also during transport.

As a result of the symmetry of the transmission part, a definable centre of gravity for fastening of the transmission is also advantageously achieved.

As a result of the compact size and simplicity of the constructive structure of the torque supporting part, a good availability worldwide and manufacture at low costs is obtained as a further advantage.

In one embodiment, both the transmission part and also the torque supporting part are each connected by means of at least one screw or bolt connection to the machine frame or the foundation of the roller press.

The plurality of screws not correctly tightened is eliminated as a result of a defined and therefore reliable bolt fastening of the torque supporting part on the transmission.

In another embodiment the transmission part is connected seamlessly to the transmission.

In one configuration of the embodiment the transmission part is cast on the transmission. Advantageously the transmission part is thus connected firmly to the transmission with at the same time low assembly effort since the casting mould is easily expanded.

In a method according to the invention for dismantling the transmission of a roller press with a transmission holder described above, the connection between transmission part and torque supporting part is firstly released. This enables the torque supporting part to be folded away with the connection to the machine frame or foundation as axis of tilt. Particularly suitable for this purpose are transmission holders in which the transmission part is connected by a bolt connection to the machine frame or foundation, otherwise the remaining connections must be released before folding away in order to enable folding away. Advantageously the installation space for work on the transmission is increased significantly by folding away. According to the prior art, the projecting transmission holders appreciably interfere during dismantling and reduce the installation space.

An exemplary embodiment of the invention is explained by reference to figures, wherein:

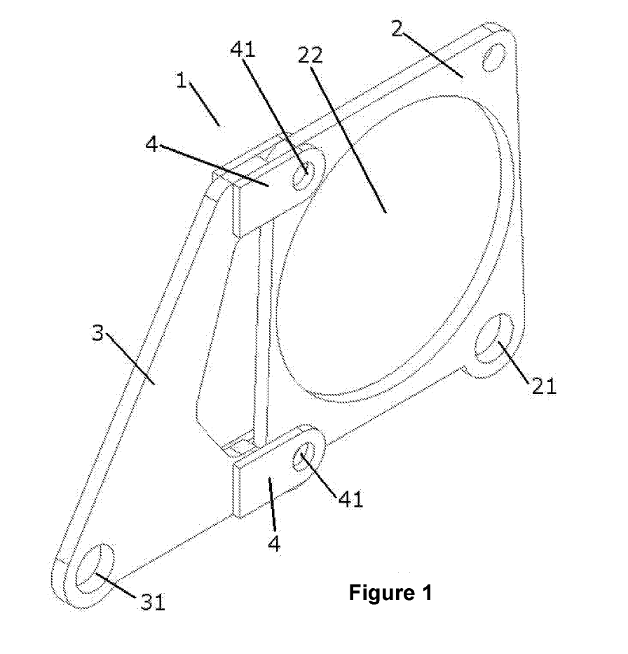

FIG. 1 shows a transmission holder according to the invention,

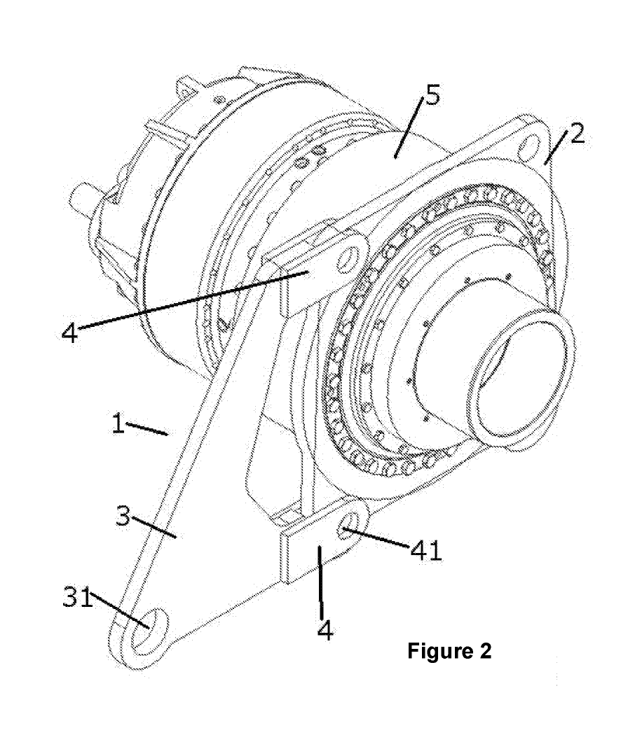

FIG. 2 shows a transmission holder fastened to a transmission and

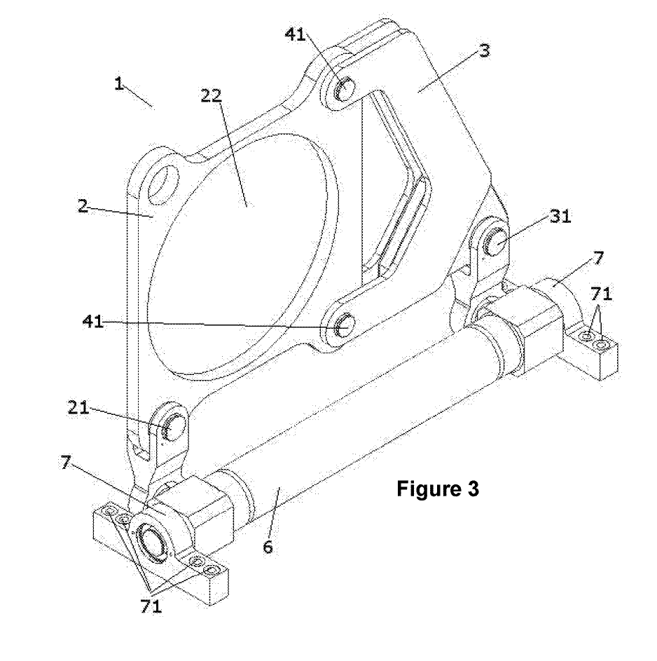

FIG. 3 shows a transmission holder according to the invention with torsion shaft.

FIG. 1 shows a transmission holder 1 which is divided into two parts according to the invention comprising a transmission part 2 and a torque supporting part 3. The transmission part 2 has a central opening 22 through which the transmission is guided in the installed state. Transmission part 2 and torque supporting part 3 of the transmission holder 1 are connected via connecting holes 41 by means of bolts (not shown here). In the area of the connecting holes 41 the torque supporting part 3 has a fork-shaped region 4, wherein the fork encloses the transmission part 2 in the area of the connecting hole 41. The transmission part 2 has another connecting hole 21 for connection to the machine frame or foundation not shown here in the same way as the torque supporting part 3 has a connecting hole 31 for connection to the machine frame or the foundation.

FIG. 2 shows the transmission holder 1 in the installed state. In this case the transmission holder 2 is cast on a transmission 5.

FIG. 3 shows a slightly different design of the transmission holder 1. Here almost the entire torque supporting part 3 is designed to be double-walled apart from in the area of the connecting hole 31. The connecting holes 21 and 31 connect the transmission holder 1 to connecting elements (also designated as mountings) 7 which hold a torsion shaft 6 at its ends and are connected via connecting holes 71 to the machine base frame or foundation. In FIG. 3 connecting bolts are shown in the connecting holes 21, 31 and 41.

Reference list

| | |
|---|---|
| 1 | Transmission holder |
| 2 | Transmission part |
| 21 | Connecting hole |
| 22 | Opening for transmission |
| 3 | Torque supporting part |
| 31 | Connecting hole |
| 4 | Fork-shaped region |
| 41 | Connecting hole |
| 5 | Transmission |
| 6 | Torsion shaft |
| 7 | Connecting element/mounting |
| 71 | Connecting hole connecting element-machine |
| | base frame |

1. Transmission holder (1) for a roller press having a two-part structure, comprising a transmission part (2) which is connected to the transmission (5) and a torque supporting part (3) which is connected to the machine frame or foundation of the roller press, wherein transmission part (2) and torque supporting part (3) of the transmission holder (1) can be firmly connected to one another and wherein the transmission part (2) has a rectangular basic shape with an opening for passage of the drive shaft of the transmission (5).

2. The transmission holder (1) according to claim 1, wherein the transmission part (2) and the torque supporting part (3) of the transmission holder are connected to one another by means of screw or bolt connection.

3. The transmission holder (1) according to claim 1, wherein the transmission part (2) has a plurality of holes for a screw connection to the transmission (5) in the area of the passage of the drive shaft of the transmission (5).

4. The transmission holder (1) according to claim 1, wherein one of the two parts of the transmission holder (1) in the connecting region to the other part is configured to be fork-shaped and thus abuts against the respectively other part on both sides and is secured by means of a screw or bolt through this region.

5. The transmission holder (1) according to claim 1, wherein the torque supporting part (3) is configured to be double-walled apart from in the region of a bolt connection (31).

6. Roller press comprising a transmission holder (1) having a two-part structure, wherein said transmission holder (1) comprises a transmission part (2) which is connected to the transmission (5) and a torque supporting part (3) which is connected to the machine frame or foundation of the roller press, wherein transmission part (2) and torque supporting part (3) of the transmission holder (1) can be firmly connected to one another and wherein the transmission part (2) has a rectangular basic shape with an opening for passage of the drive shaft of the transmission (5).

7. The roller press according to claim 6, wherein the transmission part (2) and the torque supporting part (3) of the transmission holder (1) are each connected by means of at least one bolt connection to the machine frame or the foundation of the roller press.

8. The roller press according to claim 6, wherein the transmission part (2) is connected seamlessly to the transmission (5).

9. The roller press according to claim 6, wherein the transmission part (2) is cast on the transmission (5).

10. The roller press according to claim 6, wherein the transmission part (2) and the torque supporting part (3) of the transmission holder (1) are fastened with respectively one screw or bolt connection on the machine frame or the foundation of the roller press.

11. (canceled)

12. The roller press according to claim 6, wherein the transmission part (2) and the torque supporting part (3) of the transmission holder are connected to one another by means of screw or bolt connection.

13. The roller press according to claim 6, wherein the transmission part (2) has a plurality of holes for a screw connection to the transmission (5) in the area of the passage of the drive shaft of the transmission (5).

14. The roller press according to claim 6, wherein one of the two parts of the transmission holder (1) in the connecting region to the other part is configured to be fork-shaped and thus abuts against the respectively other part on both sides and is secured by means of a screw or bolt through this region.

15. The roller press according to claim 6, wherein the torque supporting part (3) is configured to be double-walled apart from in the region of a bolt connection (31).

16. Method for dismantling a transmission of a roller press according to claim 10, comprising the transmission holder (1), said method comprising the following process steps:
releasing the connection between transmission part (2) and torque supporting part (3) and
folding away the transmission part (2) around the screw or bolt connection to the machine frame or foundation as tilt axis.
